(19) United States
(12) Patent Application Publication
(10) Pub. No.: US 2006/0127171 A1
(43) Pub. Date: Jun. 15, 2006

(54) Monolithic rotational flexure bearing and methods of manufacture

(76) Inventors: Dong H. Choi, Palo Alto, CA (US); Donald M. Moore, Arcadia, CA (US)

Correspondence Address: MORRISON & FOERSTER LLP, 755 PAGE MILL RD, PALO ALTO, CA, 94304-1018, US

(21) Appl. No.: 11/305,176

(22) Filed: Dec. 15, 2005

Related U.S. Application Data
(60) Provisional application No. 60/636,374, filed on Dec. 15, 2004.

(51) Int. Cl. F16C 11/12; F16G 11/00; F16D 1/00

(52) U.S. Cl. 403/291

(57) ABSTRACT

According to one aspect, a monolithically formed rotational flexure bearing is provided. In one example, the rotational flexure bearing includes a stationary portion, a rotating portion, and at least one flexure element. The stationary portion, rotating portion, and at the at least one flexure element are monolithically formed. The rotating portion is coupled to the stationary portion through the at least one flexure element, thereby allowing relative rotation of the rotating portion with respect to the stationary portion. The stationary portion may include a center axis portion along a rotational axis of the flexure bearing and opposing fixed plates on either end, the rotating portion positioned between the opposing fixed plates. The flexure elements may extend from the center axis portion to the rotating portion. The flexure bearing may include between 2 or more flexure elements.

### RELATED APPLICATION

This application is related to and claims benefit of previously filed U.S. provisional patent application Ser. No. 60/636,374, filed Dec. 15, 2004, and entitled “Rugged, Tunable Extended Cavity Diode Laser for Spaceflight Applications”; the entire content of which is hereby incorporated by reference in its entirety as if fully set forth herein.

### STATEMENT REGARDING FEDERALLY SPONSORED RESEARCH OR DEVELOPMENT

This invention was made with Government support under a Prime Contract between the Institute and NASA and JPL subcontract number 1245238. The Government has certain rights in the invention.

### BACKGROUND

1. Field

The present invention relates general to rotational bearings, and more particularly to monolithic rotational flexure bearings and methods of manufacture.

2. Description of Related Art

Rotational bearings are well known in the art for providing and supporting rotational motion in a wide variety of applications. Conventional journal and roller bearings, for example, have had much success in providing unlimited range of rotation angles while maintaining a relatively stable axis of rotation. Typically, a rotational bearing includes a fixed or stationary portion and a rotating portion. The stationary portion may be attached to a larger frame or base, and the rotating portion may be coupled to an element or feature that is desired to rotate relative to the stationary portion.

Conventional roller (or mechanical) bearings utilize one or more balls or rollers disposed between a stationary and rotating portion of the rotational bearing. Such bearings are generally cheap to manufacture and may be used in a wide variety of applications. Mechanical roller bearings, however, typically suffer from noise and vibration resulting, for example, from the stack of tolerances between the elements and rollers disposed therebetween. Accordingly, conventional roller bearings are generally not desirable for applications requiring precise rotational motion, e.g., with little or no axial/radial runout or small rotational angles (e.g., less than one degree) are desired. Additionally, conventional roller bearings typically include multiple parts that may require repair or lubrication periodically.

Conventional fluid bearings utilize a thin layer of liquid or gas to provide lubrication and support between the stationary and rotating portion of the bearing. For example, journal bearings typically use a fluid such as oil (but other liquids or gasses may be used) to lubricate the interface between moving portions of the rotational bearing. Fluid bearings generally have better frictional characteristics than mechanical bearings, and are generally optimized for high speed rotational motions, e.g., in disk drive motor or the like. A drawback of fluid bearings, however, includes that they generally operate poorly at low speeds and suffer from leaks or contamination of the fluid. For example, leaks or particle contamination of the lubricating fluid may cause changes in friction, which drastically reduce the performance of the bearing.

Conventional journal and roller bearings have had much success in providing an unlimited range of rotation angles with a relatively stable axis of rotation. The use of such bearings in applications that require small (or extremely limited) rotation angles, however, are generally hampered by tribology (friction-related) issues. For example, various physical phenomena including stiction, stick-slipping, and contact wearing of the bearing are well known conundrums of conventional bearings. These effects may become more problematic when repeatable and accurate small angles of rotations are desired of the rotational bearing.

Accordingly, a rotational bearing having relatively small radial and/or axial runout over small angles of rotation is desired.

### SUMMARY

According to one aspect described herein, an exemplary rotational flexure bearing is provided. In one example, the rotational flexure bearing includes a stationary portion, a rotating portion, and at least one flexure element. The stationary portion, rotating portion, and at the at least one flexure element are monolithically formed with each other. The rotating portion is coupled to the stationary portion through the at least one flexure element, thereby allowing relative rotation of the rotating portion with respect to the stationary portion. The stationary portion may include a center axis portion along a rotational axis of the flexure bearing and opposing fixed plates on either end, the rotating portion positioned between the opposing fixed plates. The flexure elements may extend from the center axis portion to the rotating portion. The flexure bearing may include between 2 and 6 flexure elements (or more).

In one example, a monolithically formed rotational flexure bearing may be integrated with a larger device, e.g., a cavity laser device. A portion of the rotational bearing, e.g., the stationary portion, may be integrated or monolithically formed as part of the device, e.g., formed with the base or package of the system.

According to another aspect, an exemplary method of manufacturing a rotational flexure bearing is provided. In one example, the method includes forming a rotational flexure bearing in a monolithic structure. The rotational flexure bearing includes a stationary portion, a rotating portion, and at least one flexure element, where the rotating portion is coupled to the stationary portion through the at least one flexure element, thereby allowing relative rotation of the rotating portion with respect to the stationary portion. In one example, the rotational flexure bearing is formed through a material subtraction process such as machining etching, electro static discharge machining, or the like. In another example, the rotational flexure bearing is formed through a material addition process such as casting, molding, rapid prototyping, or the like.

The present invention is better understood upon consideration of the detailed description below in conjunction with the accompanying drawings and claims.

### BRIEF DESCRIPTION OF THE DRAWINGS

FIG. 1 illustrates a perspective view of an exemplary monolithic flexure bearing according to one example;

FIGS. 2A-2C illustrative several views of the exemplary monolithic flexure bearing of FIG. 1;

FIGS. 3A-3E illustrate an exemplary method of forming a rotation flexure bearing monolithically;

FIGS. 4A and 4B illustrate an exemplary tool used in the manufacture of an exemplary flexure bearing;

FIGS. 5A-5C illustrate an exemplary device including an exemplary flexure bearing according to one example; and

FIGS. 6A-6C illustrate an exemplary device including an exemplary flexure bearing according to another example

### DETAILED DESCRIPTION

The following description is presented to enable a person of ordinary skill in the art to make and use the various aspects and examples of the inventions. Descriptions of specific materials, techniques, and applications are provided only as examples. Various modifications to the examples described herein will be readily apparent to those of ordinary skill in the art, and the general principles defined herein may be applied to other examples and applications without departing from the spirit and scope of the inventions. Thus, the present inventions are not intended to be limiting to the examples described and shown, but are to be accorded the scope consistent with the appended claims.

According to one aspect, an exemplary monolithic rotational flexure bearing is provided herein. Broadly speaking, flexure-based bearings are devices which operate on the principle of elastic deformation of one or more elements—typically in flexion. The flexure bearing includes a stationary portion, a rotating portion, and at least one flexure element. The at least one flexure element allows relative rotation of the stationary portion and the rotating portion. In one example, the stationary portion, rotating portion, and at least one flexure element are monolithically formed with each other, thereby providing a highly reliable and accurate rotational bearing.

In one example, a monolithic rotational flexure bearing includes a discrete number of elastically flexure elements, symmetrically disposed around an axis of rotation, thereby allowing rotation of the rotating portion of the bearing with little to no axial runout (e.g., little to no movement of the axis of rotation). In one example, features of the flexure bearing are obtained by removing material from a single monolithic structure to form the desired elements of the rotational bearing. Material may be removed using any suitable material removal technique(s) such as conventional machining, Electro-Discharge Machining (EDM), or the like. In other examples, features of the bearing may be obtained by material addition techniques such as casting, molding, rapid prototyping, and the like to form the flexure bearing as a monolithic structure. The flexure bearing may be made from a variety of materials, including, e.g., metals, sintered metal powders, polymers, single crystals, and the like. Additionally, in some examples, the flexure bearing may advantageously be fabricated in-situ, e.g., built directly connecting the rotating portion and the stationary portion within a device.

A monolithic rotational flexure bearing may provide one-dimensional rotational freedom with a limited rotational range (e.g., on the order of a few thousandths of radians), where the rotational axis is well defined and stable over the entire range of rotation. Additionally, a monolithic design of the flexure bearing reduces drawbacks of typical conventional journal bearings (such as friction-related lifetime issues and lubrication-related sensitivity to particulates).

According to another aspect, an exemplary method of forming a monolithic rotational bearing is provided herein. The exemplary method includes removing material from a monolithic structure to define a rotational portion, a stationary portion, and one or more flexure elements disposed between the rotational portion and the stationary portion, thereby providing a rotation flexure bearing. The monolithic structure may include a cylindrical shaped structure, wherein material is removed to define fixed plates connected to a central portion of the structure, the fixed plates on either of the cylindrical structure along the axis of rotation. Apertures may be formed in the fixed plates symmetrically around the axis of the cylindrical shape. Material may then be removed from the central portion of the monolithic structure to form flexure elements connecting the fixed plates with the central portion of the monolithic structure.

A rotational bearing design that lends itself to be incorporated into an assembly, e.g., to produce monolithic packages, is also a desirable feature. Incorporation into a larger assembly may reduce the number of parts and reduce or eliminate joining hardware. One exemplary application and use of a monolithic rotational flexure bearing as described herein includes integration of the bearing with a cavity laser system. The bearing provides, e.g., stable, repeatable position and orientation of the rotation axis of a rotating element within the laser system. In the context of external cavity laser design and manufacturing, in order to provide as broad a mode-hop-free wavelength tuning range as possible, it is desirable for the designer to define (and the assembly operator to rely) on a stable, repeatable position and orientation of the rotation axis of a rotating element (e.g., a retro-reflector prism in this example). Further, for applications (such as a laser package) that will be subject to harsh or inaccessible environments such as space, where there is a desire for long life and little to no maintenance required, it becomes desirable to use a monolithic flexure-based rotational bearing to reduce problems caused by contamination and routine maintenance. Even for ordinary environments, the cost-of-ownership advantage of a simpler, sturdier bearing will offer apparent advantages. Those of ordinary skill in the art will recognize that various other applications and uses are possible and contemplated.

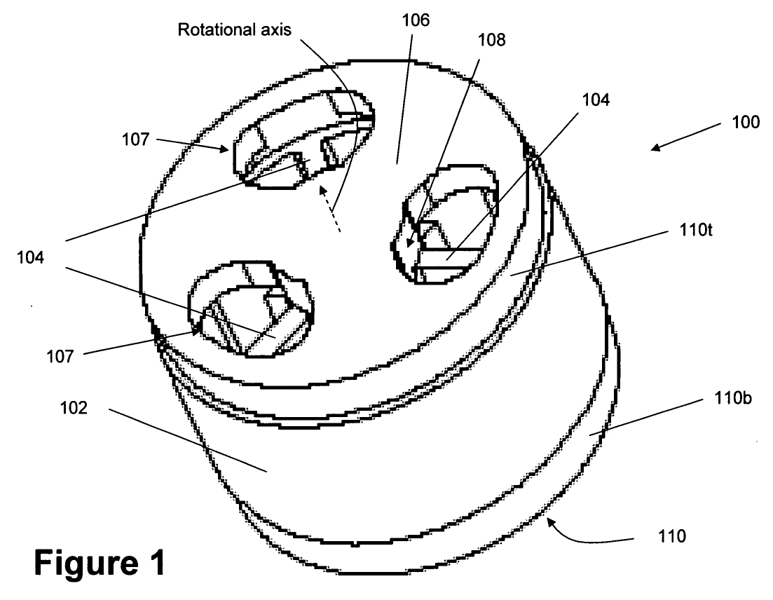

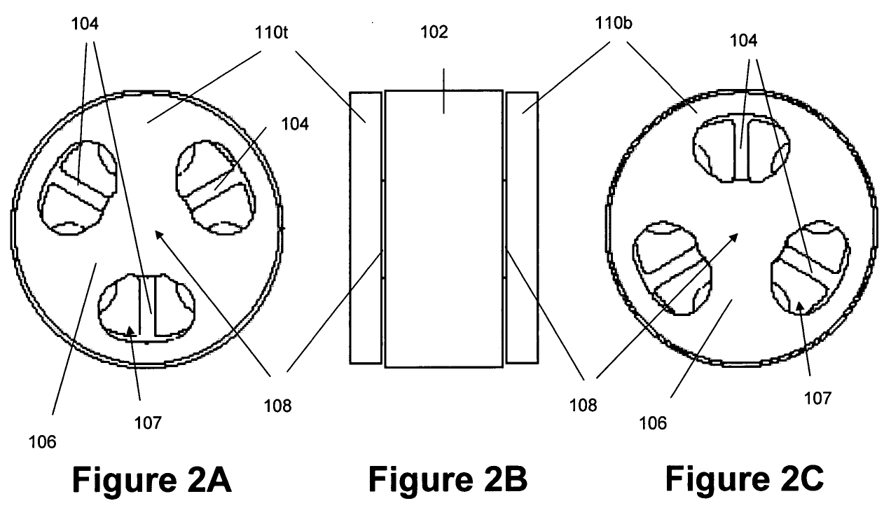

FIG. 1 illustrates a perspective view of an exemplary monolithically formed rotational flexure bearing 100 that can be used in a multi-component assembly to provide a flexible rotational coupling. FIG. 1 may be referenced in conjunction with FIG. 2, which illustrates top, bottom, and side views of exemplary flexure bearing 100. Flexure bearing 100 generally includes a rotating portion 102, a stationary portion 110 (shown in this example including fixed plates 110t and 110b on opposing ends of a center portion 108 and on either side of rotating portion 102), and flexure elements 104 disposed between rotating portion 102 and center portion 108 of the stationary portion 110 of the bearing. Center portion 108 lies generally along a rotational axis of bearing 108.

In operation, rotating portion 102 rotates relative to stationary portion 110 through flexure elements 104. In this example, stationary portion 110 includes fixed plates 110t and 110b, which may be attached to or integrated with a device, package, or the like, and rotating portion 102 may be attached or integrated with an element or device desired to rotate relative to stationary portion 110. For example, a member may extend away from rotating portion 102 and an actuator, e.g., a piezoelectric actuator or the like, may deflect the member causing rotation of rotating portion 102 relative to stationary portion 110. The terms “rotating” and “stationary” with respect to rotating portion 102 and stationary portion 110 are used for illustrative purposes only; in other examples, rotating portion 102 may be held stationary with respect to a platform or package with stationary portion 110 adapted to rotate relative to rotating portion 102. Further, in other examples, both rotating portion 102 and stationary portion 110 are capable of rotating relative to each other.

In this example, fixed plates 110t and 110b further include apertures 107 disposed generally around the axis of rotation and defining bridges 106 between apertures 107. Bridges 106 connect fixed plates 110t and 110b to the fixed center portion 108, and bridges 106 are equally spaced (e.g., angles of 120° between them). Furthermore, bridges 106 on stationary portion 110t are shifted relative to bridges 106 on stationary portion 110b by an angle that is half of the angle between bridges 106 (e.g., 60°). The arrangement and shift of bridges 106 in this example allow for an economical fabrication of the device following the material removal techniques as will be described in greater detail below. Those of skill in the art will recognize, however, that other configurations, e.g., numbers and positions of bridges or similar structures, are possible and contemplated and depend on the manufacturing techniques, desired applications, and the like.

In this exemplary design, the minimum number of bridges is two per fixed plate 110t and 110b and can be increased depending on the particular implementation. The number of flexure elements 104 is twice that of bridges in this configuration, e.g., flexure bearing 100 includes three bridges 106 per fixed plate 110t and 110b and includes six total flexure elements 104 between rotating portion 102 and center stationary portion 108. Exemplary flexure bearing 100 may provide a rotational bearing having a limited range of rotation with minimal axial runout. For example, over a small range of rotations, e.g., less than one degree to a few thousandths of radians, axial runout may be greatly reduced or eliminated relative to conventional flexure bearing designs.

The range of rotation is generally determined (at least in part) by the elastic limit of the material from which the bearing is fabricated as well as the geometry of the flexure elements, rotational portion, and stationary portion. In one example, the range of rotation is on the order of a few thousandths of a radian. The torque constant (rotation angle per applied torque) and the fundamental vibration frequency (unloaded) are generally a function of the elastic modulus, density of the material, geometry of the bearing. Those of ordinary skill in the art will recognize that the torque constant, range of rotation, and the like may be tuned for specific applications by changing the geometry, materials, dimensions, etc., of the flexure elements of the rotational flexure bearing.

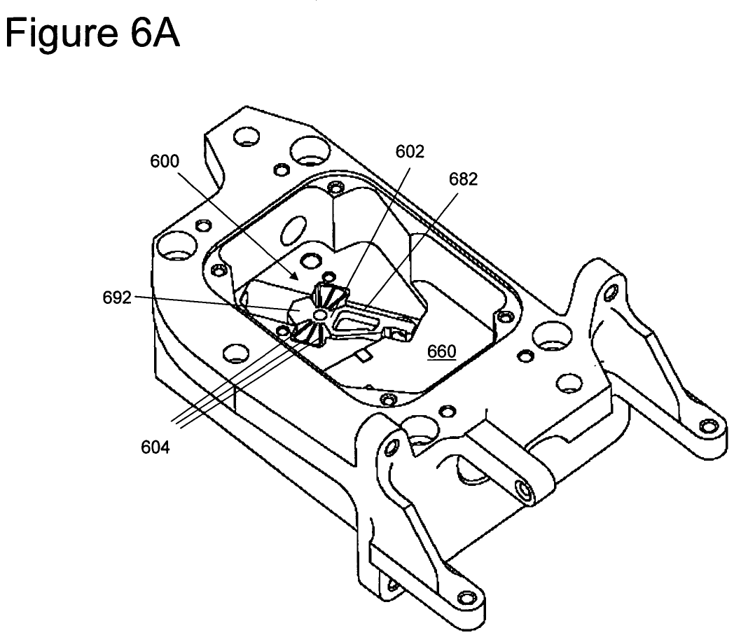

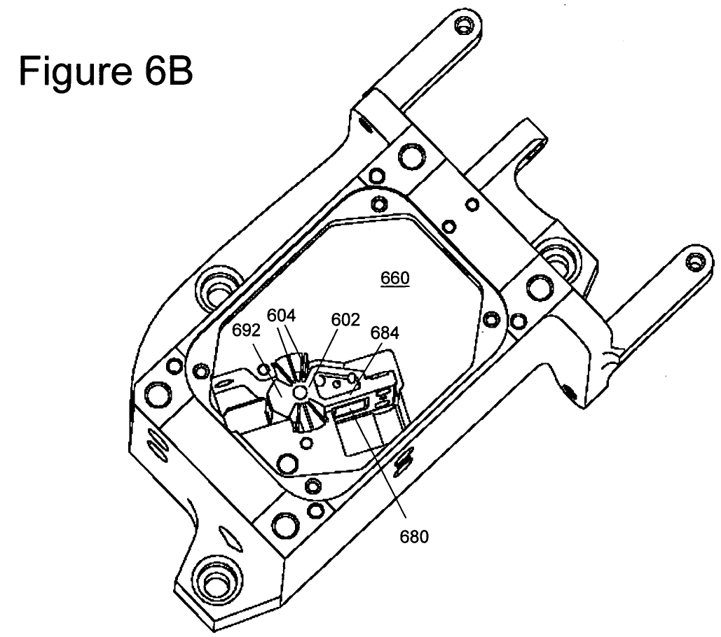

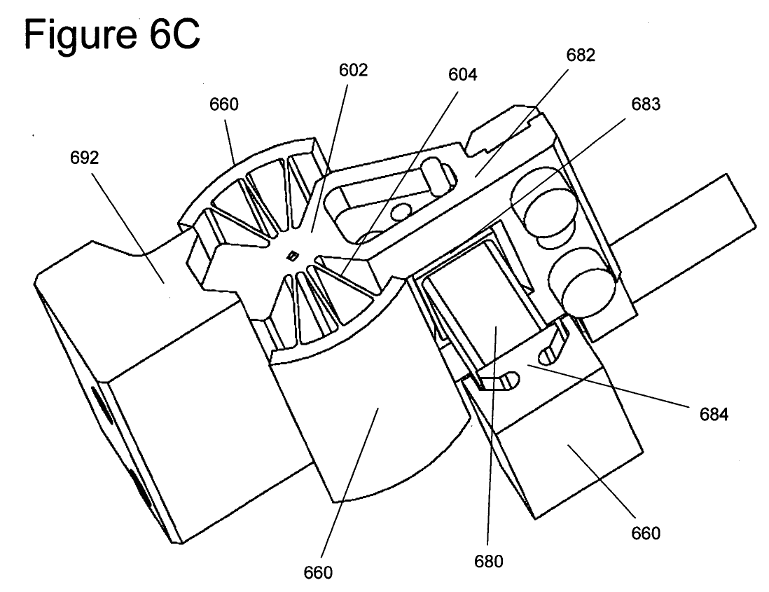

Additionally, the exemplary flexure bearing may be manufactured from a monolithic structure. Symmetrically disposing the flexure elements may allow rotation with reduced or no axial runout (translation of the rotation axis). In other examples, however, flexure elements may be disposed asymmetrically and/or circumferentially around only a portion of the rotational axis (see, e.g., FIGS. 6A and 6B and the description below). In this example, the bearing is fixed at both ends (e.g., at end plates 110t and 110b), which may provide stiffness against precession (angular changes in the axis of rotation), but in other examples the rotational member may be fixed to a stationary member only through flexure elements. Additionally, the monolithic flexure bearing is generally simple to manufacture and incorporate into an assembly such as a monolithic package as described herein.

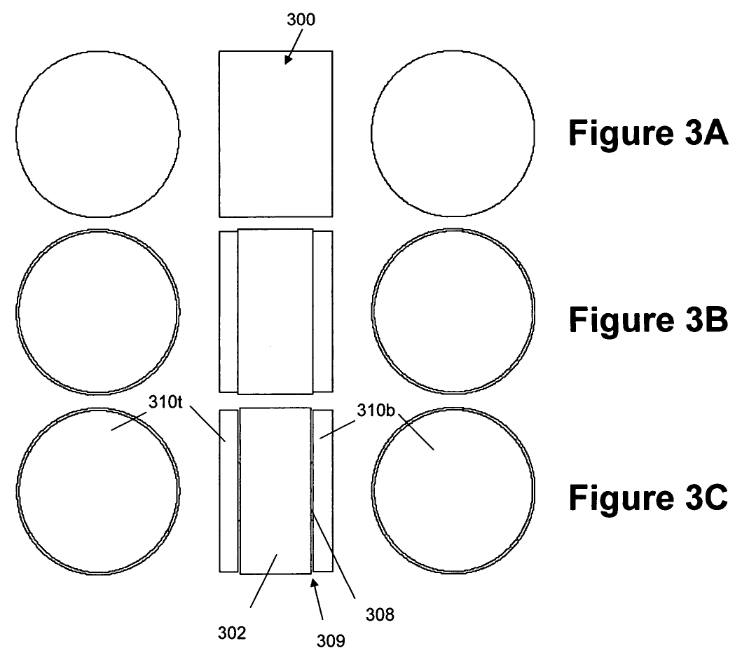

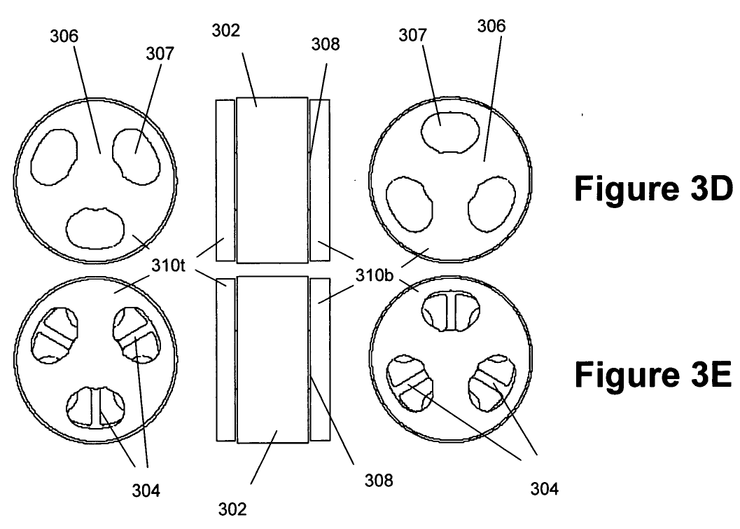

FIGS. 3A-3E illustrate an exemplary material removal process for manufacturing monolithic rotational flexure bearings, similar to flexure bearing 100 shown in FIGS. 1 and 2A-2C. Those of ordinary skill in the art will recognize that the exemplary method is illustrative only, and various other additional or alternative processing techniques and systems may be used. For example, different material removal processes as well as material addition processes will be apparent to produce similar or identical structures.

FIG. 3A illustrates a monolithic structure 300 from which a flexure bearing may be manufactured. In this example, the structure is a cylindrical shaped block with a desired length and diameter for the finished bearing. In other examples, varying shapes may be used, e.g., cubic, spherical, and the like. Additionally, the material of the monolithic structure 300 may include metals, sintered metal powders, polymers, single crystals, glasses, fiber-glasses, composite materials, and the like.

The diameter of the cylindrical block at both ends is reduced as shown in FIG. 3B. The reduced portion of the block corresponds to the fixed plates (e.g., fixed plates 110t and 110b as described above). In other examples, the fixed plates are not reduced as in this example, and may be larger than center portion 308. The material removed to reduce the diameter may be removed by any suitable process, including, for example, cutting or etching.

Slots 309 are then formed in FIG. 3C, e.g., by cutting or etching, of desired width and depth at both ends. This produces or releases a single center portion of material 302 connected through center portion 308 to two end plates 310t and 310b. Slots 309 may be formed by conventional machining (cutting tool), Electro-Discharge Machining (EDM) processes, or other suitable processes.

Openings 307 are formed on both end plates 310t and 310b in FIG. 3D, thereby defining bridges 306 between openings 307. In this example, a set of three openings 307 are formed on each end plate 310, i.e., openings 307 do not extend into center block 302 (but in other examples could extend therein). The set of openings 307 on one end plate 310t or 310b is rotated by 60° with respect to the set of openings 307 on the opposite end plate 310t or 310b. Openings 307 may be formed by any suitable process such as conventional Electrical Discharge Machining (“EDM”) or the like. In other examples, various numbers and shapes of opening 307 are possible.

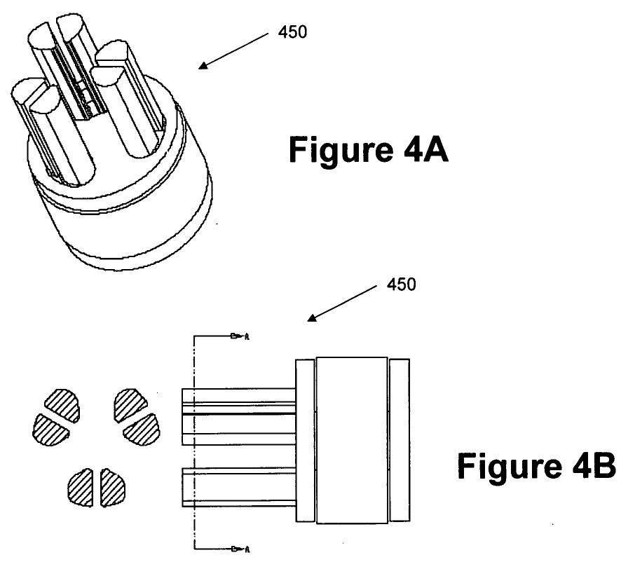

Center block 302 is then processed through openings 307 formed in end plates 310t and 310b as shown in FIG. 3E. In particular, material is removed from center block 302 to form flexure elements 304 and “hollow” out center block 302, thereby separating center block 302 from fixed plates 310t and 310b except through flexure elements 304 and center portion 308 (which runs generally along the axis of rotation). For example, the process leaves center block 302 as a hollowed out cylindrical structure which may rotate relative to center portion 308 and end plates 310t and 310b through flexure elements 304. In one example, an EDM process using a mandrel tool (shown in FIGS. 4A and 4B and described below) is used to form flexure elements 304. The bearing is machined from one side through openings 307 and then from the opposite side through openings 307. As stated, openings 307 of end plates 310 are offset 60° such that removing material from each side may create a total of 6 flexure elements 304 (3 from each side).

FIGS. 4A and 4B illustrate an exemplary device for use in an EDM process to manufacture the monolithic rotational flexure bearing device. In particular, a mandrel 450 is shown. In this example, mandrel 450 is designed to correspond to openings 307 and the number and general shape of flexure elements 304 shown in FIGS. 3A-3E. In other examples, various numbers and shapes of flexure elements 304 may be similarly formed. The EDM process may use either mandrels (typically called “sinker EDM”) or fine cutting wires (typically called “wire EDM”), both of which are widely known techniques in the art. For special materials (such as silicon) and small dimensions typical of semiconductor manufacturing microelectromechanical systems and nanotechnology, EDM process can be substituted for by other, more advanced processes to remove material, e.g. anisotropic etching (as used in semiconductor processing) and LIGA (lithography, electroforming, and molding) processes.

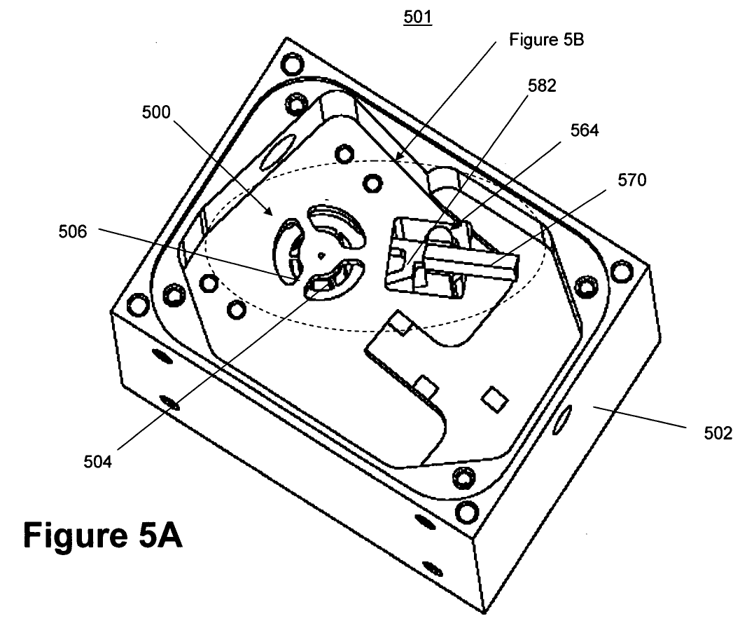

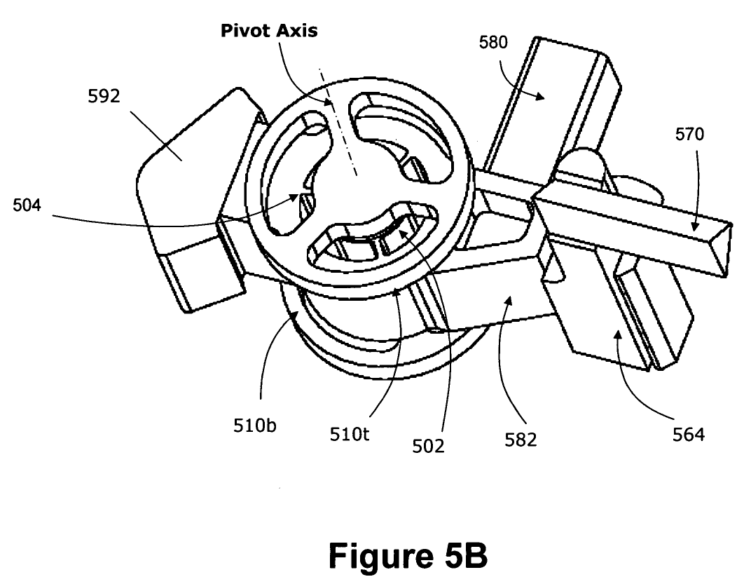

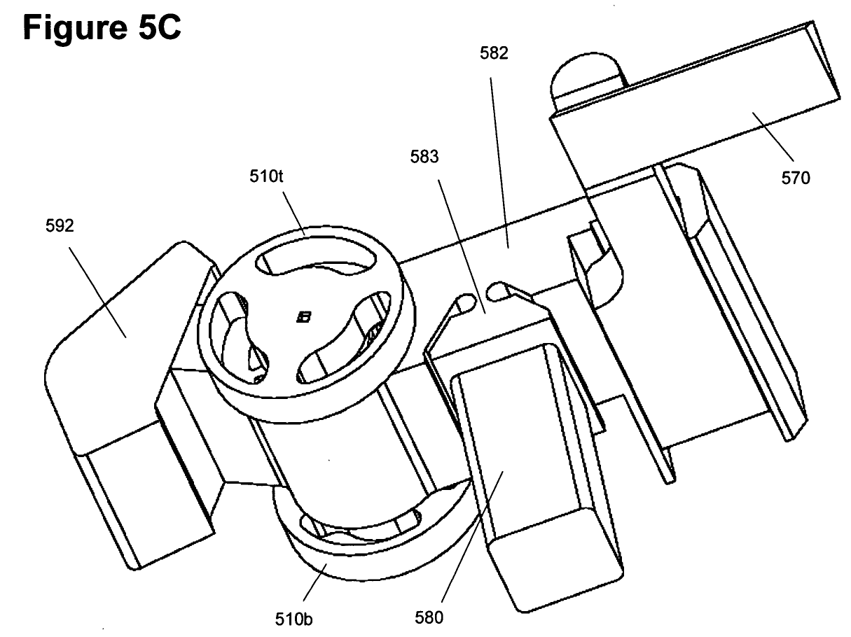

FIGS. 5A and 5B illustrate perspective views of a laser device including a monolithically formed rotational flexure bearing similar to that described with reference to FIGS. 1, 2A-3C, and 3A-3E. In particular, a rotational flexure bearing 500 (e.g., as described herein) is shown integrated into a base or foundation 502 of laser system 501. Further, foundation 502 and bearing 500 are advantageously monolithically integrated (one-piece design) where top and bottom plates 510t and 510b are formed integral with foundation 502, eliminating the need for joints and increasing the mechanical robustness of the final device. An exemplary laser device similar to that shown in FIGS. 5A and 5B is described in U.S. provisional patent application Ser. No. 60/529,001, entitled “PIEZOELECTRIC-TUNED EXTERNAL CAVITY LASER”, and filed on Dec. 12, 2003, the entire content of which is incorporated by reference herein as if fully set forth herein. Further, FIG. 5C illustrates a partial view of certain aspects of flexure bearing 500.

Exemplary flexure bearing 500 provides the ability to define the location of the rotation axis of a laser tuning device 564 in the design of the laser system 501, facilitating the assembly process. This may result in an improved stability of the rotational axis, producing a wider band of laser wavelength tuning, free of mode-hops. The simpler design added to the absence of contact elements and lubrication provides a rotational coupling with reduced concern over particle contamination and maintenance. Further, higher torque stiffness of the exemplary flexure bearing (e.g., compared to roller bearings) makes it more robust against mechanical noises (e.g., shock and vibration) by shifting higher the frequencies of natural modes of vibration.

Additionally, an actuator such as piezoelectric transducer 580 (shown in FIG. 5B) may be coupled to arm 582 associated with flexure bearing 500 so as to allow stable movement of the tuning reflector 570, or the feedback prism to achieve well-controlled frequency tuning. For example, the laser system may include a light emission source that acts as a gain medium for lasing and light amplification, dispersion optics that select a single longitudinal cavity mode of frequency out of the light spectrum from the light emission source, a tuning reflector 570 to feed and tune the selected frequency back to the gain medium for further amplification to produce the laser radiation, and a device that uses a piezoelectric transducer and flexure bearing 500 to drive tuning reflector 570 around a pivot defined by flexure bearing 500 and provide stable and continuous tuning of the laser wavelength.

In one example, the piezoelectric transducer 580 is included in a cavity formed within foundation 502 and is positioned between a static wall or member of foundation 502 and a portion of arm 582. Piezoelectric transducer 580 may further be pre-loaded during the assembly or manufacturing process. Additionally, in one example, a flexible element 583 (shown in FIG. 5C) is incorporated into arm 582, at the point of attachment to piezoelectric transducer 580 to reduce shear stresses on piezoelectric transducer 580. As arm 582 rotates with changing expansion of piezoelectric transducer 580, the flexible element rotates with arm 582 to keep the level of localized stresses in the piezoelectric transducer 580 relatively low, thereby reducing the maximum stress on piezoelectric transducer 580. Such a feature may increase the life of the piezoelectric transducer 580.

Additionally, flexure bearing 500 may further include a counter-weight 592 to further enhance rotational characteristics of the system. In particular, counter-weight 592 may distribute the weight of the arm 582 such that the center of gravity of arm 582 (including all that is attached to arm 582) is at or near the axis or rotation. This design may reduce the effect of translational vibrations or shock events that might otherwise translate into rotational movement of arm 582, thereby eliminating or greatly reducing the broadening of the laser line width (e.g., in laser applications).

The piezoelectric transducer in conjunction with the flexible bearing provides a quiet and stable driving device for wavelength tuning for such external cavity lasers. The exemplary flexure bearing confines the pivot so as to eliminate the mode hops, and the piezoelectric transducer controls the laser frequency with very fine wavelength tuning increment. This fine control of the wavelength results from the precise translation movement of the piezoelectric transducer. It will be understood by those of skill in the art that the exemplary monolithic rotational flexure bearings may be used in a variety of other applications. The present example, e.g., a cavity laser system, is provided only to illustrate one possible application.

FIGS. 6A and 6B illustrate a perspective top and bottom view of another exemplary rotational flexure bearing 600, which can by used to provide a flexible rotational coupling within a laser system, e.g., for an external cavity diode laser foundation. Further, FIG. 6C illustrates a partial view of certain aspects of flexure bearing 600. Flexure bearing 600 generally includes a rotating portion 602 which is connected to a stationary portion through symmetrically disposed flexure elements 604. In this example, flexure elements 604 are not formed circumferentially around rotating portion 602. Rotating portion 602 is aligned generally along a rotational axis of flexure bearing 600.

In operation, rotating portion 602 rotates relative to a stationary portion through flexure elements 604. As shown in FIG. 6A, the stationary portion may include a base or foundation 660, where rotating portion 602 and flexure elements 604 are monolithically formed with foundation 660. Similar to previously describes examples, a member or arm 682 may extend away from rotating portion 602 and an actuator 680 (shown in FIG. 6C), e.g., a motor, piezoelectric actuator, or the like, may deflect the member causing rotation of rotating portion 602 relative to stationary portion (e.g., the base or foundation).

In this example, tuning arm 682 is attached to the foundation 660 through six flexure elements 604, shown as blades, located symmetrically with respect to the pivot axis (axis of the center hole in the tuning arm) and the main axis of the tuning arm 682. The geometry (length, thickness, radii, or blends) and the number of flexure elements 604 may be defined in more than one configuration in order to satisfy various combinations of tuning (rotation) range and stiffness. While the tuning range is a functional parameter of the system (e.g., a laser system or the like), the stiffness is generally related to the natural frequency of the tuning arm 682, and also affects the piezoelectric element selection for actuator 680. In one example, the system may be designed by selecting a piezoelectric element for actuator 680 first and then determining a suitable geometry for flexure elements 604 to match the stiffness with the characteristics of the piezoelectric element. Additionally, the relative position of the actuator 680 (e.g., a piezoelectric element) may affect the tuning range, e.g., flipping the piezoelectric element with respect to the main axis of the tuning arm 682 would generate the same tuning range but in the opposite direction.

Additionally, in one example, a flexible element 683 is incorporated into arm 682, at the point of attachment to piezoelectric transducer 680. Additionally, another flexible element 684 (shown in FIG. 6C) may be incorporated into foundation 660. Flexible elements 683 and 684 can be used alone or in combination to reduce shear stresses on piezoelectric transducer 680. As arm 682 rotates with changing expansion of piezoelectric transducer 680, the flexible elements 683 and 684 rotate with arm 682 to keep the level of localized stresses in the piezoelectric transducer 680 relatively low, thereby reducing the maximum shear stress on piezoelectric transducer 680. Such a feature may increase the life of the piezoelectric transducer 680.

Additionally, flexure bearing 600 may further include a counter-weight 692 to further enhance rotational characteristics of the system. In particular, counter-weight 692 may distribute the weight of the arm 682 such that the center of gravity of arm 682 (including all that is attached to arm 682) is at or near the axis or rotation. This design may reduce the effect of translational vibrations or shock events that might otherwise translate into rotational movement of arm 682, thereby eliminating or greatly reducing the broadening of the laser line width (e.g., in laser applications).

The example of FIGS. 6A-6C may be manufactured from a single initial block of material (often referred to as a “blank”). The material may include Invar, Molybdenum or other suitable materials such a metallic alloys with low coefficient of thermal expansion and high thermal conductivity, from which the monolithic foundation 660 can be fabricated. In one example, features may be formed in foundation 660 using wire-EDM. The features of the rotational bearing 600, including flexure elements 602, arm 682, and counter-weight 692 may be designed with this fabrication process in mind, with many of the features formed as two-dimensional features (e.g., constant cross-section in the direction of the cutting wire). In some examples, counter-weight 692 may be separately added and include a different material than foundation 660, e.g., of varying density.

It is noted that balancing tuning arm 682 (using counter-weight 692 and/or material removal process from tuning arm 682, for example) as described with respect to this and other examples herein, may reduce sensitivity to external/ambient noise (vibrations, shocks, and the like), especially when applied to micro-mechanical components/systems.

The foundation 660 may provide all the features needed to house optical elements (e.g. diodes, gratings, etc.) and includes the tuning (rotating) arm 682 and counter-weight 692 integrated therewith. In one example, the tuning arm 682 is carved out from the initial blank and left connected to static features of foundation 660 through flexure elements 602. As described above, the geometry and configuration of flexure elements 602 are design parameters that can be changed to obtain a variety of rotational characteristics.

In one example, the tuning range (in GHz) of an exemplary device including a flexure bearing and tuning arm is a function of the voltage applied to a piezoelectric element, e.g., actuator 680. In one exemplary device, such as that shown in FIGS. 6A and 6B, the tuning range is 130 GHz, wherein the rotation of arm 682 for this tuning range is approximately 0.68 mrad (or 2.3 arcmin). Various other tuning ranges are possible and may be set for purposes of testing the device, the expected environment (e.g., temperature, pressure, etc.), and various other operating conditions.

The concept of a monolithic foundation with integrated flexure bearing(s) as described herein can be applied to other uses where it is desired to rotate an element or elements (optical, mechanical, electrical, etc.) in a narrow (e.g., on the order of 1 mrad) range at frequencies on the order of 10 kHz, for example. Applications include, but are not limited to, modulated scanning mirrors, micro-manipulators (two tuning arms working in tandem), micro-valves (where the tuning arm would squeeze a flow tubing), brakes (where the tuning arm, in the unenergized mode, would touch and press onto a rotating drum keeping it from moving—energizing the piezoelectric element would “release” the drum), and high-precision angle sensors (where the piezoelectric element, driven in sensor mode, would detect angular changes of the order of 0.01 arcsec (or 0.05 microrad)).

It will be understood that the foregoing description and drawings of preferred embodiment in accordance with the present invention are merely illustrative of the various principles of the invention, and that various modifications can be made by those skilled in the art without departing from the scope and spirit of the invention. For example, various examples described herein may be combined and altered with other devices and methods. Further, numerous other devices and processes not explicitly described herein may utilize the exemplary flexure bearing described as will be recognized by those of ordinary skill in the art. Additionally, within the description, particular examples have been discussed and how these examples are thought to address certain disadvantages in related art. This discussion is not meant, however, to restrict the various examples to methods and/or systems that actually address or solve the disadvantages. Accordingly, the present invention is defined by the appended claims and should not be limited by the description herein.

1. A rotational flexure bearing, comprising:
a stationary portion;
a rotating portion; and
at least one flexure element, wherein
the stationary portion, the rotating portion, and the at the at least one flexure element are monolithically formed with each other, and
the rotating portion is coupled to the stationary portion through the at least one flexure element, thereby allowing at least partial relative rotation of the rotating portion with respect to the stationary portion.

2. The device of claim 1, wherein the stationary portion includes a center axis portion along a rotational axis of the bearing and opposing fixed plates on either side of the rotating portion, and
the flexure elements extend from the center axis portion to the rotating portion.

3. The device of claim 2, wherein each of the opposing fixed plates include at least two apertures that define at least two bridges in each of the fixed plates.

4. The device of claim 1, comprising 2 or more flexure elements disposed between the stationary portion and the rotating portion

5. The device of claim 1, further including a member extending from the rotating portion.

6. The device of claim 5, further including a counter-weight for balancing the member about an axis or rotation.

7. The device of claim 1, wherein the bearing includes at least one of a metal, sintered metal powder, polymer, or single crystal material.

8. A laser system, comprising
a rotational bearing including:
a stationary portion;
a rotating portion; and
at least one flexure element, wherein
the stationary portion, the rotating portion, and the at the at least one flexure element are monolithically formed with each other, and
the rotating portion is coupled to the stationary portion through the at least one flexure element, thereby allowing relative rotation of the rotating portion with respect to the stationary portion.

9. The system of claim 8, wherein the system includes a cavity laser system and the rotational bearing is coupled to an arm of the laser system.

10. The system of claim 9, further comprising a counter-weight included with the rotating portion for balancing the rotating portion about an axis or rotation.

11. The system of claim 9, further including an actuator element positioned to move the arm, thereby rotating the rotating portion with respect to the stationary portion of the bearing.

12. The system of claim 11, wherein the actuator is a piezoelectric element.

13. The system of claim 12, further including at least one flexible element positioned between the piezoelectric element and the arm.

14. The system of claim 12, further including at least one flexible element positioned between the piezoelectric element and a foundation.

15. The system of claim 8, wherein the stationary portion of the rotational bearing is monolithically integrated with a base of the system.

16. The system of claim 8, wherein a portion of the rotational bearing is integrated with a movable portion of the system.

17. The system of claim 8, wherein the stationary portion includes a center axis portion along a rotational axis of the bearing and opposing fixed plates on either side of the rotating portion, and
the flexure elements extend from the center axis portion to the rotating portion.

18. The system of claim 17, wherein each of the opposing fixed plates include at least two apertures that define at least two bridges in each of the fixed plates.

19. A method for forming a monolithic flexure bearing, the method comprising:
forming a rotational flexure bearing in a monolithic structure, the rotational flexure bearing including:
a stationary portion;
a rotating portion; and
at least one flexure element, wherein
the rotating portion is coupled to the stationary portion through the at least one flexure element, thereby allowing at least partial relative rotation of the rotating portion with respect to the stationary portion.

20. The method of claim 19, wherein the rotational flexure bearing further includes at least a second flexure element positioned at the rotating portion or the stationary portion or both, wherein rotation of the rotating portion is countered to produce minimal rotation of an actuator element.

21. The method of claim 19, wherein the rotational flexure bearing further includes a counterweight integral to the monolithic structure and operable to balance rotation of the rotating portion.

22. The method of claim 19, wherein the rotational flexure bearing is formed through a two-dimensional material subtraction process.

23. The method of claim 22, wherein the material subtraction process includes electro static discharge machining.

24. The method of claim 19, wherein the rotational flexure bearing is formed through a material addition process.

25. The method of claim 24, wherein the material addition process includes one or more of casting, molding, and rapid prototyping.

26. The method of claim 19, wherein the flexure bearing is formed by a mandril in an electro static discharge machining process.

27. The method of claim 19, wherein the monolithic structure is processed to form a center axis portion along a rotational axis of the bearing and opposing fixed plates on either side of the rotating portion, and the flexure elements extend from the center axis portion to the rotating portion.

28. The method of claim 27, wherein each of the opposing fixed plates include at least two apertures that define at least two bridges in each of the fixed plates.
